(19) United States
(12) Patent Application Publication
(10) Pub. No.: US 2009/0316381 A1
(43) Pub. Date: Dec. 24, 2009

(54) LIGHT SOURCE

(75) Inventor: Ralph Kurt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,552

(22) PCT Filed: Dec. 15, 2005
(86) PCT No.: PCT/IB05/54272

§ 371 Date: Jun. 13, 2007

(30) Foreign Application Priority Data
Dec. 21, 2004 (EP) 04106775.2

(51) Int. Cl. F21V 9/14

(52) U.S. Cl. 362/19

(57) ABSTRACT

The invention relates to a light source (1) comprising one or more light-emissive elements (4) and photosensitive means (P) for detecting light from one or more of said light-emissive elements and first polarization means (30) with a first polarization direction, wherein said first polarization means is provided on or over said photo-sensitive means. The first polarization means may be interposed substantially between said light-emissive element and said photo-sensitive means. Preferably, the light source further comprises second polarization means (32) with a second polarization direction perpendicular to said first polarization direction. In this arrangement, the light-emissive element (4) is interposed substantially between the first polarization means (30) and the second polarization means (32). Accordingly, the environmental light will not hit the photosensitive means and accurate optical feedback can be accomplished.

The invention relates to a light source comprising one or more light-emissive elements and photosensitive means for detecting light from said light-emissive elements. In particular, the invention relates to a display panel or an illumination source.

Display panels employing display pixels with light-emissive elements are becoming increasingly popular. These light emitting elements may be light emitting diodes (LEDs), incorporated in or forming the display pixels that are arranged in a matrix of rows and columns. The light emissive or electroluminescent materials employed in such LEDs are suitable to generate light when a current is conveyed through these materials, such as particular polymeric (PLED) or small molecule organic (SMOLED) materials. PLED and SMOLED display panels have opened a new path to make high quality displays. The advantages of these display panels are the self-emissive technology, the high brightness, the large viewing angle and the fast response time. The LEDs are arranged such that a flow of current can be driven through these electroluminescent materials. Typically passively and actively driven matrix displays are distinguished. For active matrix displays, the display pixels themselves comprise active circuitry such as one or more transistors.

Display panels of the above-described type have been recognized to suffer from display non-uniformity as a result of degradation of the materials employed in the light-emissive elements and, for active matrix display panels, the material non-uniformity of the drive transistors.

This display non-uniformity has been found to be effectively mitigated by using optical feedback. In this approach the light output of the light-emissive elements is monitored and corrected if the light output is not satisfactory. As an example, EP-A-1 096 466 discloses an active matrix pixel within an active matrix display including a photodiode that is optically connected to a light emitting diode within the pixel to detect a portion of the luminous flux that is generated by the light emitting diode. The photodiode discharges excess charge within the pixel in response to the detected portion of luminous flux. Once the excess charge is discharged, the light emitting diode stops emitting light.

A problem associated with the prior art light source with optical feedback is that the photodiode, apart from the light of the light emitting diode, may detect environmental light as well. Accordingly, the state of the light emitting diode is not monitored accurately and, consequently, correction of the light output may be inadequate.

It is an object of the invention to provide a light source with an improved optical feedback function.

This object is accomplished by a light source comprising one or more light-emissive elements and photosensitive means for detecting light from said light-emissive elements and first polarization means with a first polarization direction, wherein said first polarization means is provided on or over said photo-sensitive means.

By positioning the first polarization means between the light-emissive element and the photosensitive means, the photosensitive means are only exposed to environmental light with a polarization direction parallel to the first polarization direction of the first polarization means. Accordingly, the monitoring of the light from the light-emissive elements is less disturbed by environmental light which is filtered by the first polarization means.

In a preferred embodiment, the light-emissive elements, the photosensitive means and the first polarization means are arranged as defined in claim 2.

A particularly advantageous embodiment of the invention is defined in claim 3. The photosensitive means in this embodiment will be hardly exposed to environmental light, as the combination of the crossed first and second polarization means effectively blocks environmental light. Light generated by the light-emissive element, however, can reach the photosensitive means to accurately monitor the luminous flux. This arrangement is particularly advantageous for top. emission display panels, since for top emission, the photosensitive means is typically arranged at least partly under the light-emissive element. The second polarization means also improve the daylight contrast of the light source.

The embodiment of the invention as defined in claim 4 has the advantage that the first polarization means may withstand subsequent process steps in manufacturing the pixel. In a particularly advantageous embodiment, the first polarization means is a wire grid polarizer, e.g. comprising small metallic strips, such as aluminum strips. Such a wire grid polarizer shows a robust performance for subsequent processing steps and may be provided as a relatively thin layer which is beneficial for the flatness of the layers provided over the wire grid polarizer.

The embodiment of the invention as defined in claim 6 provides the advantage that the reflective polarizer enhances the light output of the pixel. The reflective polarizer may be a wire grid polarizer.

The embodiment of the invention as defined in claim 7 allows the output of the photosensitive means arranged in accordance with the invention to be used for correcting the brightness of the light-emissive elements. Such a correction may be useful to accomplish display uniformity, e.g. when the quality of the light-emissive element degrades or to compensate for the differences between driving transistors between different pixels for active matrix display panels.

The embodiment of the invention as defined in claim 8 has the advantage that the photo diodes or photo transistors can be easily implemented into the stack of layers forming the pixel for a light source.

The embodiment of the invention as defined in claim 9 has the advantage that a top emission arrangement, as the effective light emission area or aperture of such an arrangement is large, prolongs the life time of the light-emissive elements and enhances the brightness of the pixel.

It should be appreciated that the above-described embodiments, or aspects thereof, may be combined.

The embodiments of the invention as defined in claims 11 and 12 are advantageous applications of the light source according to the invention. The display panels may be PLED display panels, SMOLED display panels or other types of emissive active matrix display panels for wireless as well as wired applications. The light-emissive elements are not necessarily organic LEDs, but may be inorganic LEDs as well. As an example red, green and blue inorganic LEDs may be used for an illumination source. Such illumination sources may require optical feedback to control the stability of the light intensity and the color point.

The invention will be further illustrated with reference to the attached drawings, which schematically show a preferred embodiment according to the invention. It will be understood that the invention is not in any way restricted to this specific and preferred embodiment.

In the drawings:

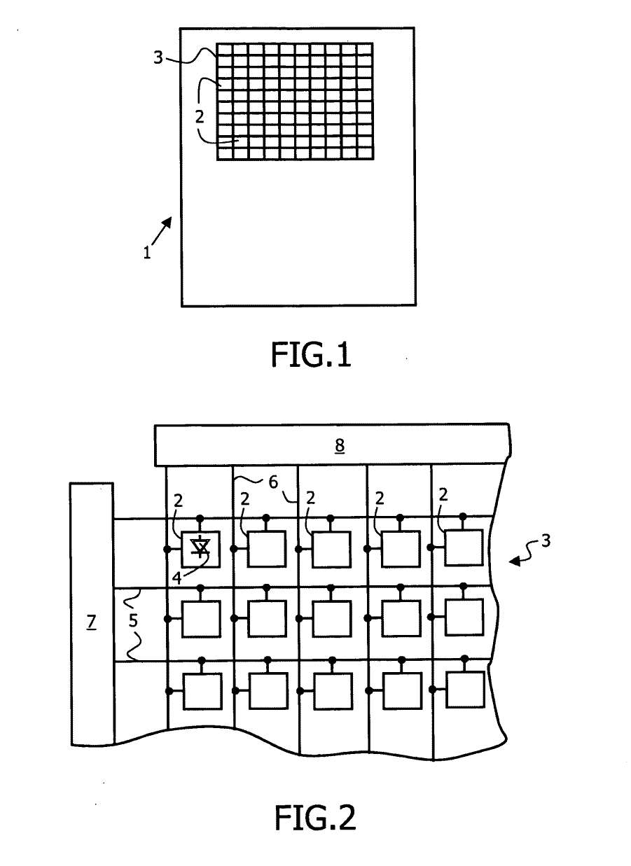

FIG. 1 schematically depicts a light source according to an embodiment of the invention;

FIG. 2 shows a simplified schematic diagram of an embodiment of an active matrix display panel;

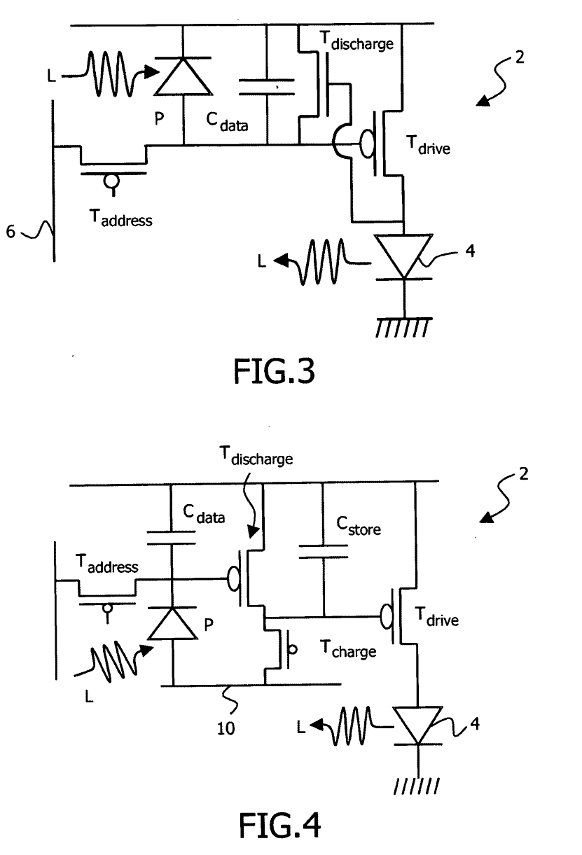

FIG. 3 shows a first known optical feedback pixel design;

FIG. 4 shows a second known optical feedback pixel design;

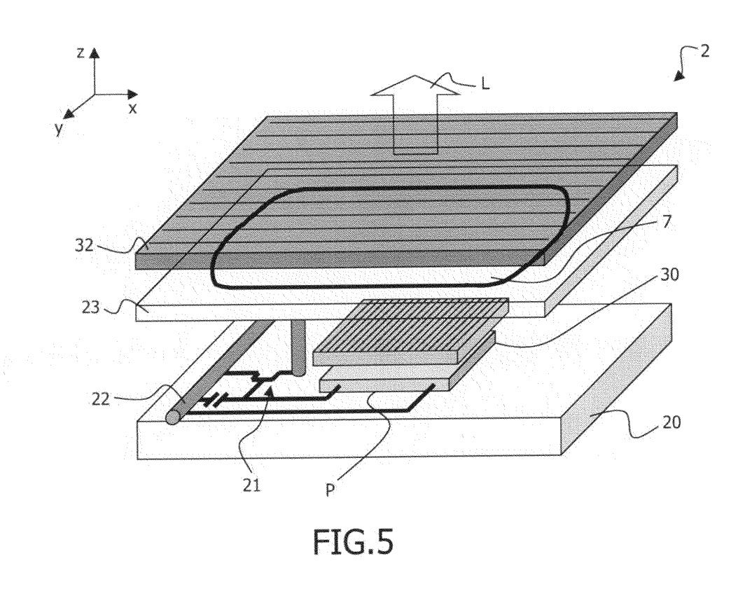

FIG. 5 shows a simplified schematic pixel diagram according to an embodiment of the invention;

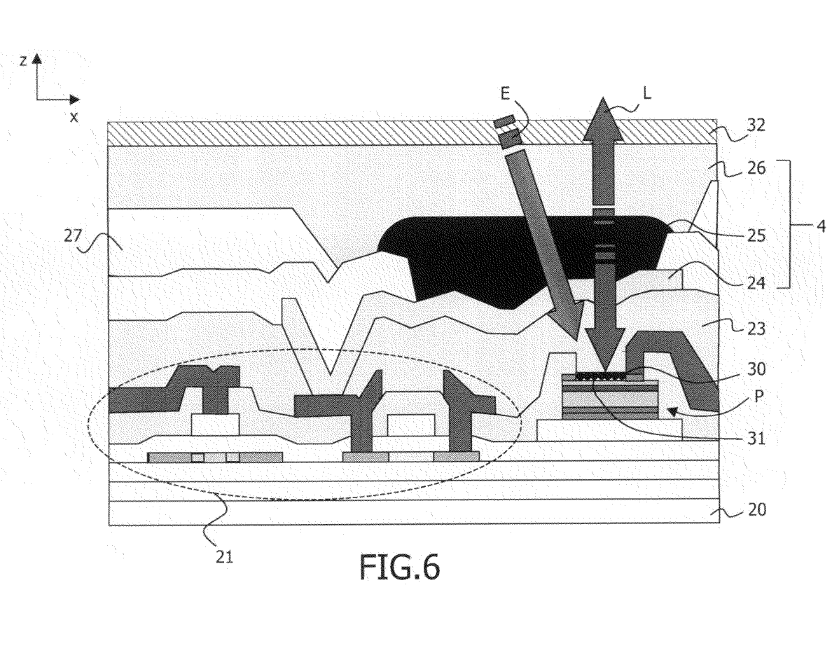

FIG. 6 shows a cross-section of a portion of a display pixel layer stack according to an embodiment of the invention, and

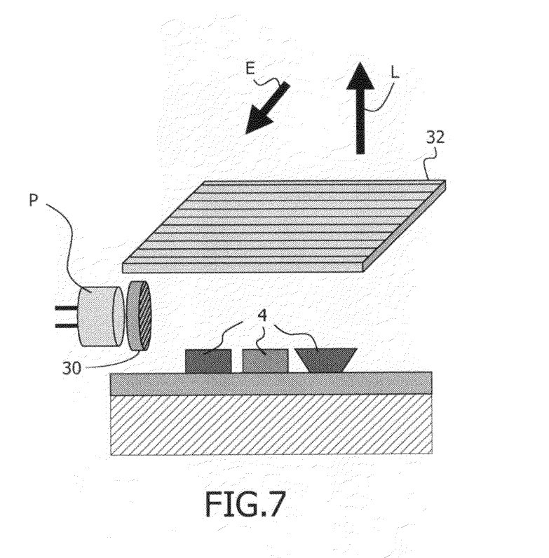

FIG. 7 shows a cross-section of an illumination source according to an embodiment of the invention.

FIG. 1 is a schematic illustration of a light source 1 according to an embodiment of the invention. The light source 1 comprises a plurality of pixels 2. The pixels 2 together form an illuminated area 3 that may represent e.g. a display panel or a illumination source. The description will now focus on display panels with reference to FIGS. 2-6. In FIG. 7 an illumination source will be briefly described in an embodiment of the invention.

FIG. 2 shows a simplified schematic diagram of a portion of an active matrix display panel 3. The display panel 3 has a row and column matrix array of regularly-spaced pixels 2 comprising light-emissive elements 4 together with associated switching means, located at the intersections between crossing sets of row (selection) and column (data) address conductors 5 and 6. The light-emissive element 4 comprises an organic light emitting diode and a pair of electrodes between which one or more active layers of organic electroluminescent material are sandwiched. Only a few pixels are shown in FIG. 2 for reasons of simplicity. In practice there may be several hundreds of rows and columns of pixels 2. The pixels 2 are addressed via the sets of row and column address conductors by a peripheral drive circuit comprising a row, scanning, driver circuit 7 and a column, data, driver circuit 8 connected to the ends of the respective sets of conductors.

FIGS. 3 and 4 show in simplified schematic form a basic display pixel 2 and drive circuitry arrangement for providing voltage-addressed operation with optical feedback to provide light output correction on the basis of monitoring the light output of the light-emissive element 4. Each pixel 2 comprises a light-emissive element 4 and associated driver circuitry. The driver circuitry has an address transistor T_{address} which is turned on by a row address pulse on the row conductor 5 from the row driver circuit 7. When the address transistor T_{address} is turned on, a voltage on the column conductor 6 from the data driver 8 can pass to the remainder of the pixel 2. In particular, the address transistor T_{address} supplies the column conductor voltage to a current source which comprises a drive transistor T_{drive} and a capacitor C_{data}. The column voltage is provided to the gate of the drive transistor T_{drive}, and the gate is held at this voltage by the capacitor C_{data} even after the row address pulse has ended.

The drive transistor T_{drive} in this circuit is implemented as a p-type TFT, so that the capacitor C_{data} holds the gate-source voltage fixed. This results in a fixed source-drain current through the transistor T_{drive}, which therefore provides the desired current source operation for the pixel 2.

Both the light-emissive element 4 itself and the transistor T_{drive} may give rise to non-uniformity in the brightness of various display pixels 2 of the display panel 3. The ageing effect on the light-emissive element 4 is due to a reduction in the efficiency of the light emitting material by carrying current. In most cases, the more current has passed through a LED, the lower the efficiency. The effect of the transistor relates to variation in the mobility's and threshold voltages between transistors T_{drive} for various pixels 2. This is particularly true for amorphous silicon low temperature polysilicon (LTPS) devices.

These effects can be compensated for by monitoring the light output of the light-emissive elements 4 and correcting the driving signals in response thereto, i.e. optical feedback.

In the pixel circuit of FIG. 3, a photodiode P discharges the gate voltage stored on the capacitor C_{data}, causing the brightness to reduce. The light-emissive element 4 will no longer emit light when the gate voltage on the drive transistor T_{drive} falls below the threshold voltage of T_{drive}, and the capacitor C_{data} will then stop discharging. The rate at which charge leaks from the capacitor C_{data} is a function of the light output L of the light-emissive element 4, so that the photodiode P functions as a light-sensitive feedback device. Once the drive transistor T_{drive} has switched off, the anode voltage of the light-emissive element 4 decreases causing a discharge transistor T_{discharge} to turn on, so that the remaining charge on the storage capacitor C_{data} is rapidly lost and the luminance of the light-emissive element 4 is switched off.

As the capacitor C_{data} holding the gate-source voltage is discharged, the drive current for the light-emissive element 4 drops gradually. Thus, the brightness falls off. This gives rise to a lower average light intensity.

FIG. 4 shows a circuit which has a constant light output L and then switches off after a time interval depending on the light output L.

The gate-source voltage for the drive transistor T_{drive} is held on a storage capacitor Cₛₜₒᵣₑ. The capacitor Cₛₜₒᵣₑ is charged to a fixed voltage from a charging line 10, by means of a charging transistor T_{charge}. Thus, the drive transistor T_{drive} is driven to a constant level which is independent of the data input to the pixel 2 when the light-emissive element 4 is to be illuminated. The brightness is controlled by varying the duty cycle, in particular by varying the time when the drive transistor T_{drive} is turned off.

The drive transistor T_{drive} is turned off by means of a discharge transistor T_{discharge} which discharges the capacitor Cₛₜₒᵣₑ. When the discharge transistor T_{discharge} is turned on, the capacitor Cₛₜₒᵣₑ is rapidly discharged and the drive transistor T_{drive} turned off.

The discharge transistor T_{discharge} is turned on when the gate voltage reaches a sufficient voltage. The photodiode P is illuminated by the light-emissive element 4 and generates a photocurrent in dependence on the light output L of the light-emissive element 4. This photocurrent charges a discharge capacitor C_{data}, and at a certain point in time, the voltage across the capacitor C_{data} will reach the threshold voltage of the discharge transistor T_{discharge} and thereby switch it on. This time will depend on the charge initially stored on the capacitor C_{data} and on the photocurrent from the photodiode P, which in turn depends on the light output L of the light-emissive element 4. The discharge capacitor C_{data} initially stores a data voltage, so that both the initial data and the optical feedback influence the duty cycle of the circuit.

It should be appreciated that there are many alternative implementations of pixel circuits with optical feedback.

The invention will now be described generally with reference to FIGS. 5 and 6.

FIGS. 5 and 6 schematically display a pixel 2 for a display panel 3 disposed on a substrate 20. The substrate 20 carries a pixel circuit 21 and photosensitive means P as has been discussed in more detail with reference to FIGS. 3 and 4. The pixel circuit 21 is connected to the light-emissive element 4. The photosensitive means P is e.g. an aSi:H NIP photodiode. However, other type of photosensitive means P, such as other types of photodiodes or phototransistors, may be applied. Further, the substrate 20 carries a power line 22.

A planarization layer 23 is deposited over the pixel circuit 21 and the photosensitive means P. The stack for the light-emissive element 4 includes a first electrode layer 24, typically the anode and comprising a high work function material e.g. indium tin oxide (ITO), Pt or Au, contacting the pixel circuit 21, organic layers 25, such as an optional buffer layer e.g. a polyethylenedioxythiophene (PEDOT) layer and a light emitting layer comprising e.g. polyphenylenevinylene (PPV), and a second electrode layer 26. The second electrode layer 26, commonly referred to as the cathode layer, may be of metal. However, for top emission pixels, the cathode layer should be transparent for the light L emitted by the light-emissive element 4. The cathode layer 26 may e.g. be made of ITO, indium zinc oxide (IZO) or aluminum zinc oxide (AZO). Alternatively or in addition thin metallic layers (typically several tens of nanometers), preferably having a low work function may be applied. Typical compositions include a low workfunction metal like Ba, Mg, LiF or Ca with a thin metal e.g. Ag or Al.

It should be appreciated that the pixel 2 may comprise further layers, some of which are shown in FIG. 6. As an example, the pixel 2 includes an insulating layer 27 for electric isolation and wetting purposes. A particularly relevant layer may be a reflective layer (not shown in FIG. 6) for reflecting light L from the light-emissive element 4 away from the substrate 20, i.e. a top emission pixel 2. The reflective layer is typically provided at or near the level of the first electrode layer 25. However, it should be appreciated that the reflective layer should not be arranged such that it blocks the path for the light L to reach the photosensitive means P. It is considered that the reflective layer is generally known in the art and requires no further explanation here.

As shown in FIGS. 5 and 6, each pixel 2 has a photosensitive means P located beneath first polarization means 30. The first polarization means 30 may be provided directly on top of the photosensitive means P. The first polarization means 30 is interposed substantially between the light-emissive element 4 and the photosensitive means P such that the photosensitive means P are positioned in the path of environmental light E entering the pixel 2. The first polarization means 30 has a first polarization direction parallel to the x-direction. The first polarization means 30 may comprise a wire grid polarizer. The wire grid polarizer 30 comprises a series of tiny aluminum strips 31. Such a wire grid polarizer is e.g. described in U.S. Pat. No. 6,122,103 of Moxtek and is herewith incorporated into the present application by reference with respect to its structure, its manufacturing method and its function. A wire grid polarizer 30 may easily withstand process steps required in manufacturing the pixel 2, such as deposition of the ITO layer 24 and the formation of the silicon dioxide insulating layer 27 which is typically performed at temperatures of about 300° C. It should be appreciated, however, that the first polarization means comprises an organic polarizer, such as a mixture of liquid crystal and polymer material.

The first polarizing means 30 may be a reflective polarizer. Such a reflective polarizer reflects the light L, not transmitted to the photodiode P, back, i.e. away from the substrate 20.

The pixel 2 further comprises second polarization means 32 with a second polarization direction (y-direction) substantially perpendicular to the first polarization direction of the first polarization means 30. The light-emissive element 4 is interposed substantially between the first polarization means 30 and the second polarization means 32.

It should be appreciated that the polarization means may comprise several parts, such as a circular polarizer or a linear polarizer in combination with a wavelength plate or a combination thereof.

In operation, signals from the driving circuitry 21 trigger light emission L from the light-emissive element 4. Approximately 50% of the light is directly output from the pixel 2, whereas the remaining portion is directed towards the substrate 20. The portion of the remaining portion with a polarization direction parallel to the first polarization direction of the wire grid polarizer 30 will hit the photodiode P. This light thus is reliably monitored and may be used for correction of the light output as e.g. described with reference to FIGS. 3 and 4.

Environmental light E from outside the pixel 2 passes the second polarization means 32 only for light with a polarization direction parallel to the second polarization direction of these means 32. However, as a result of the crossed polarization directions (i.e. the perpendicular orientation of the first polarization direction and the second polarization direction) of the first and second polarization means 30, 32, the environmental light E that passed the second polarization means 32 is effectively blocked by the first polarization means 30 and will not hit the photodiode P. Consequently, light emitted from the light-emissive element 4 is allowed to hit the photodiode P while environmental light E is effectively blocked and will not disturb monitoring of the light-emissive element 4.

The second polarization means 32 enhances the daylight contrast of the pixel 2, since environmental light E passing the second polarization means 32 will be blocked by these second polarization means 32 after reflection in the pixel 2.

As already described, it may be advantageous to reflect the remaining portion that does not hit the photodiode P away from the substrate. This can be accomplished by employing a reflecting wire grid polarizer 30 and a reflective layer in the pixel stack 2. The non-transmitted or reflected portion of the light L will have the appropriate polarization to be transmitted through the second polarization means 32 and thus contribute to the light output of the pixel 2.

FIG. 7 shows an illumination source 1 comprising light-emissive elements 4. The illumination source 1 is a white light luminaire comprising a red (R), green (G) and blue (B) light-emissive element 4 and a photosensitive means P for detecting light L from said light-emissive elements 4. First polarization means 30 are provided over the photodiode P and second polarization means 32, with a polarization direction substantially perpendicularly to the polarization direction of the first polarization means 30, are provided over the light-emissive elements 4. The first polarization means 30 substantially shield the photodiode P from environmental light E.

It should be noted that the above-mentioned embodiment illustrates, rather than limit, the invention, and that those skilled in the art will be able to design many alternative embodiments without departing from the scope of the appended claims. The gist of the invention relates to providing polarization means between a light-emissive element and photosensitive means such that blocking of environmental light may be performed effectively. The shielding of the photosensitive means from environmental light does not solely rely on geometrical shielding but employs polarization phenomena.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A light source (1) comprising one or more light-emissive elements (4) and photosensitive means (P) for detecting light from one or more of said light-emissive elements and first polarization means (30) with a first polarization direction, wherein said first polarization means is provided on or over said photo-sensitive means.

2. The light source (1) according to claim 1 comprising an array of pixels (2), each of said pixels comprising:
a light-emissive element (4):
a photosensitive means (P) for detecting light from said light-emissive element;
a first polarization means (30) with said first polarization direction wherein said first polarization means is interposed substantially between said light-emissive element and said photo-sensitive means.

3. The light source (1) according to claim 2, wherein said light source further comprises second polarization means (32) with a second polarization direction substantially perpendicular to said first polarization direction and wherein said light-emissive element (4) is interposed substantially between said first polarization means (30) and said second polarization means (32).

4. The light source (1) according to claim 1, wherein said first polarization means (30) comprises an inorganic polarizer.

5. The light source (1) according to claim 4, wherein said inorganic polarizer (30) comprises a wire grid polarizer.

6. The light source (1) according to claim 1, wherein said first polarization means (30) comprises a reflective polarizer.

7. The light source (1) according to claim 1, wherein said photosensitive means (P) is adapted to generate an output indicative of the brightness of said light (L) and each of said pixels (2) comprises driving circuitry (21) for driving a current through said light-emissive element (4), wherein said driving circuitry is controlled in response to said output of said photosensitive means.

8. The light source (1) according to claim 1, wherein said photosensitive means (P) comprises a photo diode or a photo transistor.

9. The light source (1) according to claim 1, wherein an electrode (26) is provided over said light-emissive element (4) arranged to drive a current through said light-emissive element which electrode is substantially transparent for said light (L) of said light emissive element.

10. The light source (1) according to claim 1, wherein said light-emissive element is an organic light emitting diode.

11. The light source (1) according to claim 1, wherein said light source is a display panel, preferably a top-emission display panel.

12. The light source (1) according to claim 1, wherein said light source is an illumination source, preferably a white light illumination source comprising red, green and blue light-emissive elements (4).
